(19) United States
(12) Patent Application Publication
(10) Pub. No.: US 2024/0351170 A1
(43) Pub. Date: Oct. 24, 2024

(54) CLAMPING DEVICE AND PROCESSING DEVICE

(71) Applicant: SCHUNK Electronic Solutions GmbH, St. Georgen (DE)

(72) Inventors: Sven Flaig, Niedereschach (DE); Mattias Kiebe, Tuttlingen (DE); Stefan Ringwald, Elzach (DE)

(21) Appl. No.: 18/638,801

(22) Filed: Apr. 18, 2024

(30) Foreign Application Priority Data
Apr. 21, 2023 (DE) 10 2023 110 267.2

(51) Int. Cl. B25B 5/16; B25B 5/02

(52) U.S. Cl. CPC B25B 5/163; B25B 5/02

(57) ABSTRACT

A clamping device (400) for gripping and clamping a flat material (12) extending along a material plane (11) includes clamping jaws (402). The clamping jaws include a first clamping jaw (404) and a second clamping jaw (406) extending parallel to a clamping axis (408). The first and/or second clamping jaws are pivotable about a clamping rotational axis (410) running parallel to the clamping axis between open and closed positions. The first clamping jaw has a first clamping surface (414) and the second clamping jaw has a second clamping surface (416). The first clamping jaw has a clamping element (418) projecting relative to the first clamping surface and the second clamping jaw has a clamping recess (420) that is set back from the second clamping surface. In the closed position, the clamping recess accommodates the clamping element so that the flat material is gripped and clamped simultaneously.

### BACKGROUND

This disclosure relates to a clamping device for gripping, clamping and repeated positioning a flat material extending along a material plane.

### SUMMARY

Flat materials, in particular anode and cathode foils, are required in the electronics industry and in particular in the production of batteries for e-mobility.

For the purposes of this application, flat materials are to be understood as single- or multi-layer layers or foils, wherein the layers or foils have a considerably greater longitudinal and transverse extent than a thickness. In addition, the flat material is designed to be flexible, so that without support the flat material deviates substantially from a flat shape over its longitudinal and transverse extent. In addition, the flat material is at least substantially impermeable to gas, so that the flat material can be held by suction. In addition, the flat material or its layers are of monolithic design. The flat materials can in particular comprise plastic or metal, wherein metal-coated plastics or plastic-coated metals are also conceivable. The flat material can be designed as a flat material strip portion. The flat material can be, for example, a busbar foil with the dimensions 200 mm×280 mm, wherein the foil comprises graphite and is coated with aluminum or copper.

The fastening and clamping of such flat materials is complex due to the thinness and flexibility of the flat material. In particular, laser cutting of the flat material makes high demands on the gripping and clamping process due to the requirements of repeatable positioning of the flat material and the subsequent removal of the cut piece and the waste.

The disclosure is therefore based on the object of providing a clamping device for simple, reliable and reproducible gripping and clamping of flat material.

The object on which the disclosure is based is achieved by a clamping device having the features of claim 1. The clamping device has at least two opposing pairs of clamping jaws, wherein the at least two pairs of clamping jaws has a first clamping jaw extending parallel to a clamping axis and a second clamping jaw extending parallel to the clamping axis. The first clamping jaw is preferably formed in one piece. The second clamping jaw is preferably formed in one piece. The first clamping jaw is preferably arranged above the flat material to be clamped and the second clamping jaw is preferably arranged below the flat material to be clamped, or vice versa. The first clamping jaw and/or the second clamping jaw can be pivoted about a clamping rotational axis between an open position and a closed position. In the open position, a flat material can be provided in and removed from the clamping device. In the closed position, the flat material is gripped and fastened in place by the clamping device. When the flat material is gripped in the clamping device, the clamping axis and the clamping rotational axis run parallel to the material plane. The clamping rotational axis runs parallel to the clamping axis.

The first clamping jaw has a first clamping surface and the second clamping jaw has a second clamping surface. The first clamping surface and the second clamping surface extend along the clamping axis.

The first clamping surface and the second clamping surface each have at least one first section for gripping the flat material in the material plane in the closed position, at least one second section for deforming the flat material out of the material plane and clamping the flat material in the closed position, and at least one third section for providing a cavity for accommodating distortions of the flat material during clamping in the closed position. When the flat material is deformed out of the material plane, the flat material is deformed in such a way that a substantial part of the flat material continues to lie in the material plane, in particular at the first sections and between the two pairs of clamping jaws, and a further part of the flat material no longer lies in the material plane, in particular at the second sections. By means of the second section, the flat material has to cover a longer distance, so that a tensile force is created between the pairs of clamping jaws. This is further reinforced by the fact that the flat material is clamped in the material plane at the first section and deformed out of the material plane at the second section.

The first clamping jaw has a clamping element as the second section projecting relative to the first section and/or the second section. The clamping element extends along the clamping axis and preferably has a constant cross-section. The second clamping jaw has a clamping recess as a second section set back relative to the first section. The clamping recess extends along the clamping axis and preferably has a constant cross-section. The clamping element and/or the clamping recess are preferably formed integrally with the corresponding clamping jaw. In the closed position, the clamping recess accommodates the clamping element or the clamping element engages in the clamping recess so that a flat material provided in the clamping device is simultaneously gripped and clamped. Due to the longer path which the flat material has to cover in the region of the clamping element and of the clamping recess, when the flat material is being gripped it is simultaneously also clamped. It is thus ensured that the prerequisites for reliable processing of the flat material are already present when the flat material is fastened in place in the clamping device, in that in particular undesired distortions or overlaps in the flat material are prevented.

It is advantageous if, in the open position, the pair of clamping jaws has an opening angle of at least 90°, in particular of at least 130°, preferably of at least 150°, and by preference of at least 180°. The clamping device is preferably of a mouth-shaped design. By movement of the lower jaw, in particular the second jaw, over at least 45°, preferably over at least 90°, it is ensured that a provided flat material can be securely gripped. When the lower jaw is pivoted from the open position into the closed position, the provided flat material is raised and one end of the flat material is shifted into the engagement region of the clamping device. The greater the opening angle due to the pivoting of the upper jaw, the more easily a flat material can be provided at the clamping device.

It is advantageous if the first clamping jaw has a first bar portion and/or a second bar portion, wherein the first bar and/or the second bar portion builds the first section. The first bar portion and/or the second bar portion preferably extend parallel to the clamping axis and in particular, when the flat material is gripped in the clamping device, parallel to the material plane. It is also advantageous if the clamping element is arranged between the first bar portion and the second bar portion. Preferably, the clamping element also projects relative to the first bar portion and/or the second bar portion. The first bar portion preferably has a first land width and/or a first land height. The second bar portion preferably has a second land width and/or a second land depth.

The first clamping jaw preferably has a first groove portion and a second groove portion, wherein the first groove portion and/or the second groove portion builds the third section. The first groove portion and/or the second groove portion preferably extend parallel to the clamping axis and in particular, when the flat material is gripped in the clamping device, parallel to the material plane. It is also advantageous if the clamping element is arranged between the first groove portion and the second groove portion. Preferably, the first groove portion and/or the second groove portion are set back relative to the clamping element and/or to the first bar portion and/or to the second bar portion. In the closed position, the first groove portion and the second groove portion each form a cavity which is delimited in particular by the clamping surface, the clamping element and the associated bar portion. During gripping and clamping, the clamping element and the clamping recess can cause distortions and deformations of the flat material in the region of the clamping element and of the clamping recess. Should a gripping force then be applied to this region in addition to the clamping element, the flat material could be damaged and possibly tear. The flat material can extend in a load-free manner into the cavity provided by the first groove portion and the second groove portion. The flat material can thus be gripped and clamped in a particularly gentle manner. In the region of the first groove portion and of the second groove portion, the flat material is preferably not contacted by the second clamping jaw. The first groove portion and the second groove portion are preferably set back relative to the gripped flat material. When no flat material is clamped, the first clamping jaw and the second clamping jaw do not come into contact in their closed position in the region of the first groove portion and/or of the second groove portion.

The first groove portion preferably has a first groove width and/or a first groove depth. The second groove portion preferably has a second groove width and/or a second groove depth. Preferably, the first land width and the first groove width have a ratio between 1:0.5 and 1:2, in particular between 1:0.8 and 1:1.5, preferably between 1:0.9 and 1:1.1. Preferably, the second land width and the second groove width have a ratio between 1:0.5 and 1:2, in particular between 1:0.8 and 1:1.5, preferably between 1:0.9 and 1:1.1. Preferably, the first land height and the first groove depth have a ratio between 1:0.5 and 1:2, in particular between 1:0.8 and 1:1.5, preferably between 1:0.9 and 1:1.1. Preferably, the second land height and the second groove depth have a ratio between 1:0.5 and 1:2, in particular between 1:0.8 and 1:1.5, preferably between 1:0.9 and 1:1.1.

It is advantageous if the first groove portion is arranged between the first bar portion and the clamping element. It is advantageous if the second groove portion is arranged between the second bar portion and the clamping element. The first groove portion preferably adjoins the first bar portion on one side and the clamping element on the other side. The second groove portion preferably adjoins on one side the second bar portion and on the other side the clamping element.

It is advantageous if the second clamping jaw has a first surface portion and a second surface portion, wherein the first section is built by the first surface section and/or the second surface section. The first surface portion and/or the second surface portion preferably extend parallel to the clamping axis and in particular, when the flat material is gripped in the clamping device, parallel to the material plane. It is also advantageous if the clamping recess is arranged between the first surface portion and the second surface portion. Preferably, the clamping recess is set back relative to the first surface portion and/or the second surface portion.

It is advantageous if, in the closed position, the groove section, in particular a groove bottom of the groove section, and the second clamping jaw, in particular the surface sections, are arranged at a distance from each other in order to form a cavity. For the purposes of the disclosure, the spaced-apart arrangement is to be understood to mean that, in the closed position, the groove section and the second clamping jaw are further apart than, for example, the bar section and the surface section and/or the thickness of the flat material.

An advantageous development provides that the clamping element and/or the clamping recess is partially circular or elliptical in shape parallel to the clamping axis. The clamping element forms a convex portion and the clamping recess forms a concave portion. The first clamping surface and the second clamping surface are preferably designed to be complementary to one another, in particular with the exception of in the region of the first groove portion and the second groove portion.

Another advantageous development provides that the first clamping jaw and/or the second clamping jaw are each arranged on a jaw lever, so that the first clamping jaw and/or the second clamping jaw are arranged at a distance from the clamping rotational axis. This results in a longer movement path of the clamping jaws, so that it can be ensured that the lower clamping jaw scoops beneath the flat material to be gripped and then during the further movement into the closed position carries with it or lifts up the flat material to be gripped. The jaw lever is preferably arranged between the relevant clamping jaw and at least one clamping rotary drive driving the clamping jaws. The at least one jaw lever can be designed integrally with the clamping jaws. The corresponding jaw lever is arranged at its free end on a drive element of the clamping rotary drive.

Preferably, the first clamping jaw and/or the second clamping jaw each have a first jaw end and a second jaw end located opposite the first jaw end along the clamping axis. A first jaw lever can preferably be arranged on the clamping jaw in the region of the first jaw end. A second jaw lever can preferably be arranged on the clamping jaw in the region of the second jaw end. It is advantageous if one clamping rotary drive or two clamping rotary drives are provided per jaw end. The first jaw ends of the first clamping jaw and of the second clamping jaw can be coupled to a common clamping rotary drive. The same applies to the second jaw ends.

A preferred embodiment provides that the pair of clamping jaws can be displaced along a linear axis running perpendicular to the clamping axis. When a flat material is gripped in the clamping device, the clamping axis and the linear axis run parallel to the material plane. Accordingly, a gripped flat material can be additionally clamped in addition to clamping by means of the clamping element. In addition, it is conceivable that flat materials with different dimensions, in particular with regard to the longitudinal extent of the flat material running parallel to the linear axis, can be gripped and clamped.

It is also advantageous if a clamping linear guide extending along the linear axis and a linear slide displaceable in or on the clamping linear guide are provided. The linear slide can thereby be displaced on the clamping linear guide by means of a clamping linear drive. The pair of clamping jaws and in particular the jaw levers and in particular the clamping rotary drives are preferably arranged on the linear slide.

A further preferred embodiment provides that a clamping frame is provided with a first frame side and with a second frame side opposite the first frame side along the linear axis, wherein a first pair of clamping jaws is provided on the first frame side and a second pair of clamping jaws opposite the first pair is provided on the second frame side. Accordingly, the flat material can be gripped and clamped on a first material side and a second material side. The clamping frame preferably has a frame arch with a first frame arm and a second frame arm, wherein the first pair of clamping jaws can be arranged on the first frame arm and the second pair of clamping jaws can be arranged on the second frame arm. An additional holding device for the flat material, a media supply, in particular a vacuum supply, and/or a sensor device for checking whether and how a flat material is clamped, can preferably be provided on the frame arch. The clamping frame can furthermore be arranged on a magazine having a plurality of clamping frames.

The description further comprises a clamping device according to claim 11, wherein a clamping linear guide extending along the linear axis and a linear slider displaceable on the clamping linear guide are provided, wherein the pair of clamping jaws is arranged on the linear slider.

The object on which the disclosure is based is further achieved by a processing device for processing flat material extending along a material plane. The processing device in this case has at least one clamping device according to the disclosure for gripping and clamping the flat material. In addition, the processing device preferably has a cutting device, in particular a laser device, for cutting the flat material into a cut piece. In addition, the processing device can have a holding device for holding the flat material before it is gripped by the clamping device and for holding a cut piece next to the clamping device after cutting. Furthermore, it is advantageous if a magazine is provided which has in each case two clamping devices and in particular a holding device, so that the flat material can be processed at least one magazine space while the cut piece and the waste can be removed and a new piece of flat material can be provided at at least one further magazine space.

Further details and advantageous embodiments of the disclosure can be found in the following description, by which embodiments of the disclosure are further described and explained.

### BRIEF DESCRIPTION OF THE DRAWINGS

FIG. 1 shows a perspective view of a clamping device according to the disclosure with a pair of clamping jaws;

FIG. 2 shows a schematic side view of the pair of clamping jaws according to FIG. 1;

FIG. 3 shows a perspective view of a magazine with two clamping devices, comprising in each case two clamping devices according to FIG. 1;

FIG. 4 shows a schematic plan view of the magazine according to FIG. 3; and

FIG. 5 shows a perspective view of a processing device according to the disclosure with a magazine according to FIG. 3.

### DETAILED DESCRIPTION

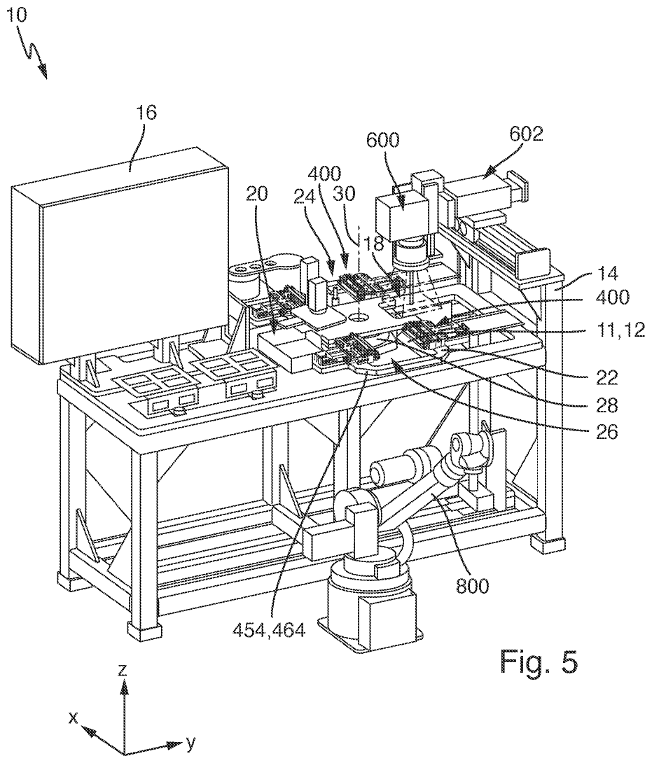

The processing device 10 shown in FIG. 5 is used for processing flat materials 12 which extend along a material plane 11 and are in particular flexible and substantially impermeable to gas. Such flat materials 12 are, for example, paper or foils. The flat materials 12 can be formed in one or more layers, wherein the base material and/or the coating material can be made of plastic or metal. In particular for battery production, foils having a base material based on graphite and a coating material based on copper or aluminum are to be produced. Due to the small thickness and flexible properties of the flat material 12, special demands must be made on the processing device 10.

According to FIG. 5, the processing device 10 has a device housing 14 and a control cabinet 16. In the device housing 14, the processing device 10 has a processing region 18 and a loading region 20. Furthermore, the processing device 10 has an x-axis X, a y-axis Y running perpendicular to the x-axis X and a z-axis Z running perpendicular to the x- and y-axes. In the loaded state, the material plane 11 of the flat material 12 runs parallel to the x-axis and the y-axis and perpendicular to the z-axis.

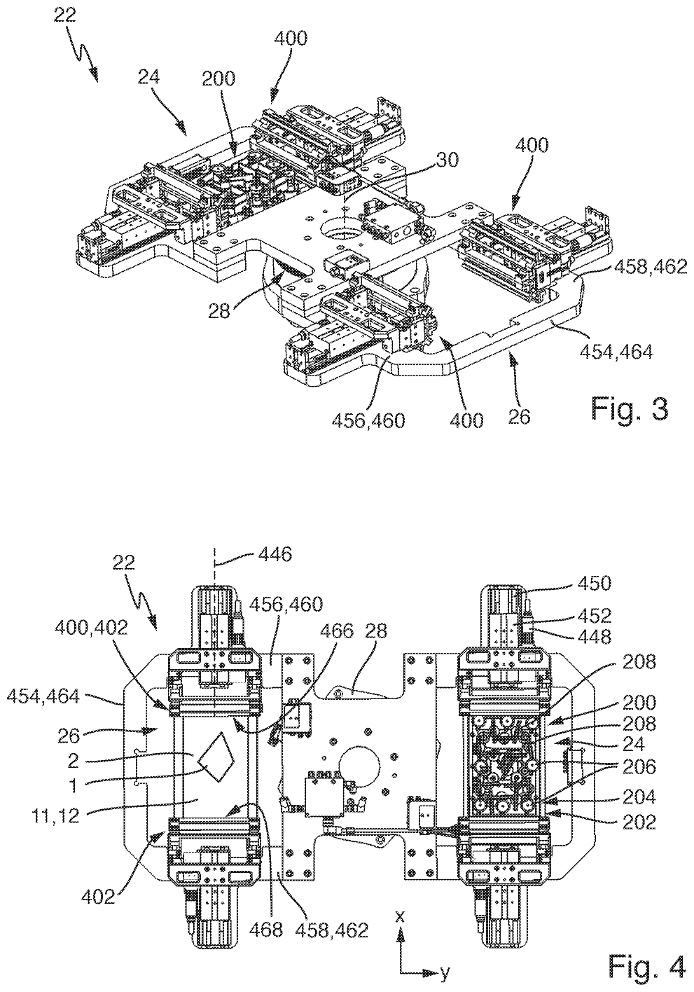

According to FIGS. 3 and 4, the processing device 10 has a magazine 22 with a first magazine position 24 and a second magazine position 26. By means of a rotary drive 28, the magazine 22 can be rotated about a magazine axis 30 running parallel to the z-axis, so that in each case a magazine space 24, 26 in a processing position can be pivoted into the processing region 18 and the other magazine space 24, 26 can be pivoted into a loading position into the loading region 20. The processing position and the loading position are arranged opposite one another along the y-axis. In addition, the magazine 22 can be rotated in such a way that both the first magazine space 24 and the second magazine space 26 can be pivoted in an intermediate position outside the processing region 18 and outside the loading region 20.

Each magazine position 24, 26 has a holding device 200 and a mouth-shaped clamping device 400. Accordingly, the holding device 200 and the clamping device 400 along with the associated magazine position 24, 26 are pivoted into the processing position, the loading position or the intermediate position.

According to FIGS. 3 and 4, the holding device 200 has a base plate 202 and a work plate 204 arranged in the base plate 202. The work plate 204 comprises a ferromagnetic material, preferably iron. Along the x-axis and the y-axis, the base plate 202 and/or the work plate 204 preferably have the outer dimensions of the flat material 12 to be processed. A plurality of magnetic vacuum devices 206, in particular in the form of a vacuum nozzle, and magnetic support modules 208, in particular in the form of a brush, are provided on the work plate 204, wherein these are individually arrangeable depending on the movement path of the laser beam or on the outer contour of the cut piece 1.

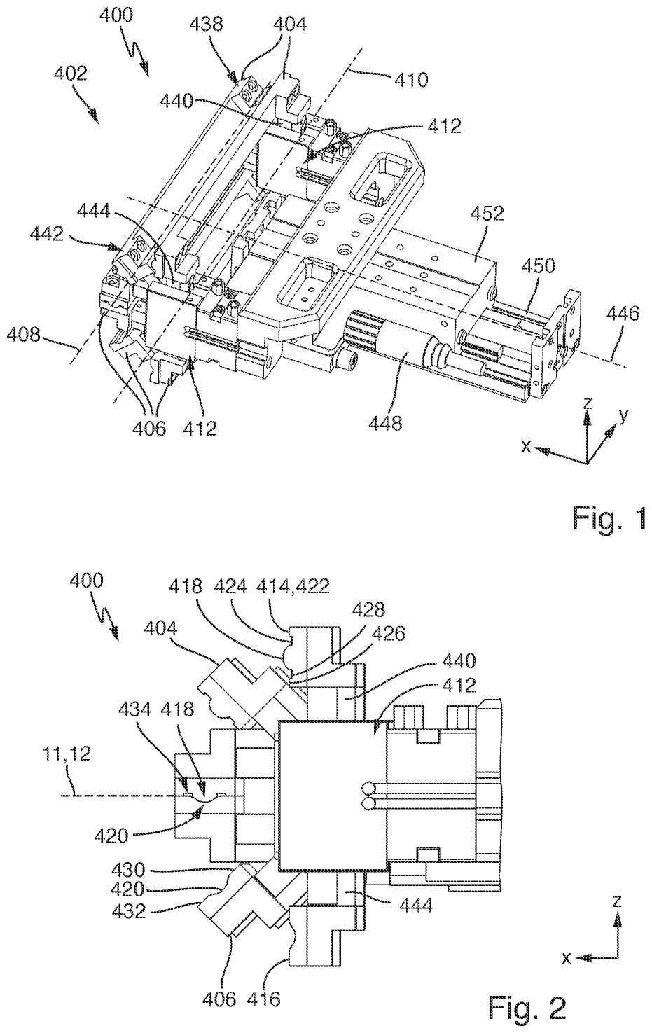

According to FIGS. 1 and 2, the clamping device 400 comprises two pairs of clamping jaws 402 located opposite each other along the x-axis, wherein each pair of clamping jaws 402 has an upper first clamping jaw 404 and a lower second clamping jaw 406.

The first clamping jaw 402 and the second clamping jaw 404 extend parallel to a clamping axis 408, wherein the clamping axis 408 extends parallel to the y-axis. The first clamping jaw 404 and the second clamping jaw 406 can each be rotated about a common clamping rotational axis 410 by means of at least one clamping rotary drive 412, thus being displaced between an open position and a closed position. In the open position, a flat material 12 can be inserted into the clamping device 400 and in the closed position the flat material 12 is fastened in place and clamped in the clamping device 400. FIGS. 1 and 2 show the open position (parallel to the z-axis), the closed position (parallel to the x-axis) and an intermediate position (45° relative to the x-axis and the z-axis) of the clamping jaws 404, 406, wherein the first clamping jaw 404 pivots upwards into the open position and the second clamping jaw 406 pivots downwards into the open position. When the flat material 12 is gripped in the clamping device 400, the clamping axis 408 and the clamping rotational axis 410 run parallel to the material plane 11.

The first clamping jaw 404 has a first clamping surface 414 and the second clamping jaw 406 has a second clamping surface 416. The first clamping jaw 404 has a clamping element 418 that projects or is convex relative to the first clamping surface 414. The clamping element 418 is partially circular in shape. The clamping element 418 extends with a constant cross-section along the clamping axis 408. The second clamping jaw 406 has a clamping recess 420 which is recessed or concave relative to the second clamping surface 416. The clamping recess 420 is designed to be partially circular in shape, in particular complementary to the clamping element 418. The clamping recess 420 extends with a constant cross-section along the clamping axis 408. The clamping element 418 and the clamping recess 420 are designed integrally with the corresponding clamping jaw 404, 406. In the closed position, the clamping recess 420 accommodates the clamping element 418 or the clamping element 418 engages in the clamping recess 420, so that a flat material 12 provided in the clamping device 400 is simultaneously gripped and clamped. Due to the longer path which the flat material 12 has to travel in the region of the clamping element 418 and of the clamping recess 420, when the flat material 12 is gripped, the flat material 12 is also simultaneously clamped. This ensures that the prerequisites for the assured processing of the flat material 12 are already present when the flat material 12 is fastened in place in the clamping device 400, in that in particular unwanted distortions or overlaps in the flat material 12, at least in the engagement region of a laser device 600, are prevented.

The first clamping surface 414 has, in addition to the clamping element 418, a first bar portion 422 and a first groove portion 424 adjacent thereto, wherein the first groove portion 424 is arranged between the first bar portion 422 and the clamping element 418. The first clamping surface 414 further has a second bar portion 426 and a second groove portion 428 adjacent thereto, wherein the second groove portion 428 is arranged between the second bar portion 426 and the clamping element 418. A groove portion 424, 428 thus adjoins the clamping element 418 on both sides. The bar portions 422, 426 and the groove portions 424, 428 extend parallel to the material plane 11 when the flat material 12 is gripped in the clamping device 400.

The second clamping surface 416 has in addition to the clamping recess 420 a first surface portion 430 and a second surface portion 432, wherein the clamping recess 420 is arranged between the surface portions 430, 432. The surface portions 430, 432 extend parallel to the material plane 11 when the flat material 12 is gripped in the clamping device 400.

In the closed position, the first groove portion 424 and the second groove portion 428 each form a cavity 434 delimited in particular by the first clamping surface 414, the clamping element 418 and the associated bar portion 422, 426. During gripping and clamping, the clamping element 418 and the clamping recess 420 can cause distortions and deformations of the flat material 12 in the region of the clamping element 418 and the clamping recess 420. Should a gripping force then be applied to this region in addition to the clamping element 418, the flat material 12 could be damaged and possibly tear. The flat material 12 can extend in a load-free manner into the cavity 434 provided by the first groove portion 424 and the second groove portion 428. The flat material 12 can thus be gripped and clamped in a particularly gentle manner. In the region of the first groove portion 424 and the second groove portion 428, the flat material 12 is not contacted by the second clamping jaw 406. The first groove portion 424 and the second groove portion 428 are set back relative to the gripped flat material 12. When no flat material 12 is being gripped, the first clamping jaw 404 and the second clamping jaw 406 do not come into contact in the closed position in the region of the first groove portion 424 and the second groove portion 428.

For coupling the clamping jaws 404, 406 to the at least one clamping rotary drive 412, each clamping jaw 404, 406 comprises a first jaw lever 440 at a first jaw end 438 and a second jaw lever 444 at a second jaw end 442 opposite the first jaw end 438 along the clamping axis 408. The jaw lever 440, 444 is arranged at its free end on a drive element (not shown) of the clamping rotary drive 412. The clamping jaws 404, 406 are not connected between the jaw levers 440, 444. For pivoting the clamping jaws 404, 406 between the open position and the closed position, one or two clamping rotary drives 412 can be provided for each jaw end 438, 442.

In addition, by means of a clamping linear drive 448, the clamping device 400 according to FIGS. 1 and 3-4 can be designed to be displaceable between a near position and a remote position along a linear axis 446 running perpendicular to the clamping axis 408. In the near position, the pair of clamping jaws 402 are displaced towards the flat material 12 in order to reduce the tension of the flat material 12 being fastened in place. In the remote position, the pair of clamping jaws 402 are displaced away from the flat material 12 in order to increase the tension of the flat material 12 being fastened in place. For this purpose, the clamping linear drive 448 has a clamping linear guide 450 and a linear slide 452 that can be displaced on the clamping linear guide 450. The pair of clamping jaws 402 and the at least one clamping rotary drive 412 are arranged in or on the linear slide 452. When a flat material 12 is gripped in the clamping device 400, the clamping axis 408 and the linear axis 446 run parallel to the material plane 11.

For gripping and clamping a flat material 12 on both sides, the clamping device 400 according to FIGS. 3-5 comprises two pairs of clamping jaws 402 opposite each other along the linear axis 446, wherein a first material side 466 of the flat material 12 is clamped in the first pair of clamping jaws and a second material side 468 opposite the first material side 466 along the x-axis is clamped in the second pair of clamping jaws 402. The corresponding clamping linear guide 450 is arranged with the linear slide 452 and the pair of clamping jaws 402 on a clamping frame 454. For this purpose, the clamping frame 454 has a first frame side 456 and a second frame side 458 opposite the first frame side 456, wherein a pair of clamping jaws 402 is provided for each frame side 456, 458. The clamping frame 454 has a first frame arm 460 and a second frame arm 462 and a frame arch 464 connecting the first frame arm 460 and the second frame arm 462. The first frame arm 460 is associated with the first frame side 456 and the second frame arm 462 is associated with the second frame side 458, wherein the clamping linear guide 450 is arranged on each frame arm 460, 462. The holding device 200 for the flat material 12, a media supply (not shown), in particular a vacuum supply and/or a sensor device (not shown) for checking whether and how a flat material 12 is clamped can preferably be provided on the frame arch 464.

As shown in FIGS. 3 and 4, the clamping frame 454 can furthermore be arranged on the magazine 22 with a plurality of clamping devices 400. A first clamping frame 454 with two pairs of clamping jaws 402 is arranged on the magazine 22 on one side and a further clamping frame 454 with two pairs of clamping jaws 402 is arranged on the magazine 22 on the other side.

In the processing region 18, according to FIG. 5, the processing device 10 has the laser device 600. The laser device 600 is set up in such a way that a laser beam emitted by the laser device 600 and running substantially parallel to the z-axis is directed onto the flat material 12, and an energy input into the flat material 12 occurs at an impingement point, so that the flat material can be cut into a cut piece 1 and waste 2 at the impingement point. The cut piece 1 is the product ultimately to be produced. The laser beam can preferably be moved over a work region, wherein the work region substantially corresponds to the longitudinal and transverse extent of the flat material 12. The laser device 600 preferably has an axis system 602 for displacing the laser beam along the x-axis by means of a first linear axis 604 and along the y-axis by means of a second linear axis 606. It is also conceivable for the axis system 602 to have a third linear axis (not shown) for displacement along the z-axis.

The flat material 12, the cut piece 1 and the waste 2 can be handled by means of a transport device 800 according to FIG. 5.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

### LIST OF REFERENCE NUMBERS

X X-axis
Y Y-axis
Z Z-axis
1 Cut piece
2 Waste
10 Processing device
11 Material plane
12 Flat material
14 Device housing
16 Control cabinet
18 Processing region
20 Loading region
22 Magazine
24 First magazine space
26 Second magazine space
28 Rotary drive
30 Magazine axis
200 Holding device
202 Base plate
204 Work plate
206 Vacuum devices
208 Support modules
400 Clamping device
402 Pair of clamping jaws
404 First clamping jaw
406 Second clamping jaw
408 Clamping axis
410 Clamping rotational axis
412 Clamping rotary drive
414 First clamping surface
416 Second clamping surface
418 Clamping element
420 Clamping recess
422 First bar portion
424 First groove portion
426 Second bar portion
428 Second groove portion
430 First surface portion
432 Second surface portion
434 Cavity
438 First jaw end
440 First jaw lever
442 Second jaw end
444 Second jaw lever
446 Linear axis
448 Clamping linear drive
450 Clamping linear guide
452 Linear slide
454 Clamping frame
456 First frame side
458 Second frame side
460 First frame arm
462 Second frame arm
464 Frame arch
466 First material side
468 Second material side
600 Laser device
602 Axis system
800 Transport device

What is claimed is:

1. A clamping device (400) for gripping and clamping a flat material (12) extending along a material plane (11) with at least two opposing pairs of clamping jaws (402), wherein the two pairs of clamping jaws (402) each has a first clamping jaw (404) extending parallel to a clamping axis (408) and a second clamping jaw (406) extending parallel to the clamping axis (408),
wherein the first clamping jaw (404) and/or the second clamping jaw (406) can be pivoted about a clamping rotational axis (410) running parallel to the clamping axis (408) between an open position and a closed position,
wherein the first clamping jaw (404) has a first clamping surface (414) and the second clamping jaw (406) has a second clamping surface (416),
wherein the first clamping surface (414) and the second clamping surface (416) each have at least one first section for gripping the flat material (12) in the material plane (11) in the closed position,
wherein the first clamping surface (414) and the second clamping surface (416) each have at least one second section for deforming the flat material (12) out of the material plane (11) and clamping the flat material (12) in the closed position, and wherein the first clamping surface (414) and/or the second clamping surface (416) have at least one third section for providing a cavity for accommodating distortions of the flat material (12) during clamping in the closed position.

2. The clamping device (400) according to claim 1, wherein the first clamping jaw (404) has a clamping element (418) as a second section projecting relative to the first section and/or the third section and the second clamping jaw (406) has a clamping recess (420) as a second section set back relative to the first section of the section clamping jaw (406), wherein, in the closed position, the clamping recess (420) accommodates the clamping element (418), so that a flat material (12) provided in the clamping device (400) is gripped and clamped simultaneously.

3. The clamping device (400) according to claim 1, wherein, in the open position, the pair of clamping jaws (402) has an opening angle of at least 90°, in particular of at least 130°, preferably of at least 150°, and by preference of at least 180º.

4. The clamping device (400) according to claim 1, wherein the first clamping jaw (404) has as a first section a first bar portion (422) and a second bar portion (426), wherein the clamping element (418) is arranged between the first bar portion (422) and the second bar portion (426).

5. The clamping device (400) according to claim 1, wherein the first clamping jaw (404) has as the third section a first groove portion (424) and a second groove portion (428), and wherein, in particular in the closed position to provide a cavity, the first groove portion and the second groove portion, in particular a groove portion ground of the first groove portion (424) and of the second groove portion (428), are spaced apart from the second clamping surface (416),
and/or wherein the clamping element (418) is arranged between the first groove portion (424) and the second groove portion (428).

6. The clamping device (400) according to claim 5, wherein the first groove portion (424) is arranged between the first bar portion (422) and the clamping element (418) and/or wherein the second groove portion (428) is arranged between the second bar portion (426) and the clamping element (418).

7. The clamping device (400) according to claim 1, wherein the second clamping jaw (406) has as a first section a first surface portion (430) and a second surface portion (432), and wherein the clamping recess (420) is arranged between the first surface portion (430) and the second surface portion (432).

8. The clamping device (400) according to claim 1, wherein the clamping recess (420) and/or the clamping element (418) is partially circular or elliptical in shape parallel to the clamping axis (408).

9. The clamping device (400) according to claim 1, wherein the first clamping jaw (404) and/or the second clamping jaw (406) are each arranged on at least one jaw lever (440, 442), so that the first clamping jaw (404) and/or the second clamping jaw (406) are arranged at a distance from the clamping rotational axis (410).

10. The clamping device (400) according to claim 9, wherein the first clamping jaw (404) and/or the second clamping jaw (406) each have a first jaw end (438) and a second jaw end (442) opposite the first jaw end (438) along the clamping axis (408), wherein a first jaw lever (440) is arranged in the region of the first jaw end (438) and/or a second jaw lever (444) is arranged in the region of the second jaw end (442).

11. The clamping device (400) according to claim 1, wherein the pair of clamping jaws (402) can be displaced along a linear axis (446) running perpendicular to the clamping axis (408).

12. The clamping device (400) according to claim 1, wherein a clamping frame (454) with a first frame side (456) and a second frame side (458) opposite the first frame side (456) is provided, wherein a first pair of clamping jaws (402) is provided on the first frame side (456) and a second pair of clamping jaws (402) opposite the first pair (402) is provided on the second frame side (458).

13. The clamping device (400) according to claim 5, wherein the first clamping surface (414) and the second clamping surface (416), with the exception of the groove portions (424, 428), are designed complementary to each other.

14. The clamping device (400) according to claim 1, further comprising at least one clamping rotation drive (412) for driving the clamping jaws (404, 406).

15. A processing device (10) for processing flat material (12) extending along a material plane (11), comprising a clamping device (400) according to claim 1.
